(19) United States
(12) Patent Application Publication
(10) Pub. No.: US 2008/0019866 A1
(43) Pub. Date: Jan. 24, 2008

(54) Lab-On-A-Chip For An On-The-Spot Analysis And Signal Detection Methods For The Same

(76) Inventors: Se-Hwan Paek, Seoul (KR); Joo-Eun Kim, Busan (KR)

Correspondence Address: HYUN JONG PARK, 41 WHITE BIRCH ROAD, REDDING, CT, 06896-2209, US

(21) Appl. No.: 11/720,177

(22) PCT Filed: Dec. 1, 2005
(86) PCT No.: PCT/KR05/04084

§ 371 Date: May 24, 2007

(30) Foreign Application Priority Data
Dec. 9, 2004 (KR) 10-2004-0103462

(51) Int. Cl. G01N 21/78; B01J 19/00

(52) U.S. Cl. 422/55; 422/68.1

(57) ABSTRACT

The present invention relates to a lab-on-a-chip version of biosensor for an on-the-spot analysis whose analytical performances were remarkably improved, by incorporating commercial membranes, traditionally used for rapid diagnostics, into microfluidic channels engraved on the surface of a plastic chip, as follows: 1) reduction of sample size; 2) realization of variable functions for total analysis; and 3) transfer of medium by capillary action without the assistance of an external force.

### TECHNICAL FIELD

The present invention relates to a lab-on-a-chip version of biosensor for an on-the-spot analysis whose analytical performances were remarkably improved, by incorporating commercial membranes, traditionally used for rapid diagnostics, into microfluidic channels engraved on the surface of a plastic chip, as follows: 1) reduction of sample size; 2) realization of variable functions for total analysis; and 3) transfer of medium by capillary action without the assistance of an external force.

### BACKGROUND ART

Rapid analytical devices based on chromatography using the lateral flow of medium through micro-pores present within the matrices of membrane pads have been conventionally applied for the diagnoses of various diseases and symptoms (References: S. H. Paek et al., 2000, Methods, Vol. 22, page 53-60; S. H. Paek et al., 1999, Biotechnol. Bioeng., Vol. 62, page 145-153; Y Kasahara et al., 1997, Clin. Chimi. Acta, Vol. 267, page 87-102). Despite their simplicity in use, one of the major drawbacks in routine, frequent application has been the induction of severe pain, in the case of using whole blood for specimens, because of a large amount of sampling. To reduce the sample size, membrane pads can typically be cut smaller than 4 mm in width, which would make it difficult to hold them in a precise arrangement. This causes a low reproducibility of analysis and inaccuracy in detection. For a device utilizing a flow-through mode (References: A. E. Chu, 2001, U.S. Pat. No. 6,284,194 B1), the same problems must be addressed when membranes are of smaller sizes. These are probably the major reasons that products handling low capacity samples have not yet appeared in the market. The sample volume required by current, commercially available rapid analytical devices is typically in the range of 15 to 200 L (References: A. J. T\ddot{υ}dos et al., 2001, Lab. Chip, Vol. 1, page 83-95).

As a trend of recent development in analytical devices, a technology of micro-electrical, mechanical systems (MEMS) has been used for the fabrication of micro-fluidic channels (References: A. E. Guber et al., 2004, Chem. Eng. J., Vol. 101, page 447-453; T. Fujii, 2002, Microelectr. Eng., Vol. 61/62, page 907-914) and microscopic structures (References: O. A. Schueller et al., 1999, Sens. Acuat. A, Vol. 72, page 125-139) on a variety of solid surfaces. This could enable us to fabricate a miniaturized lab-on-a-chip device that totally performs various processes, for instance, pre-treatment of a nano-liter sample, physical separation of bio-molecules, and generation of a signal in proportion to the analyte concentration. Such total analysis may be carried out on a 1×1 mm sized plastic chip or possibly one that is even smaller. However, since the present status of this technology remains undeveloped in some aspects, such as reproducibility in mass production of the chip, the time of its practical application appears considerably delayed (References: O. A. Schueller et al., 1999, Sens. Acuat. A, Vol. 72, page 125-139).

Both analytical resources mentioned, membranes used for rapid analysis and micro-fluidic channels enabling the miniaturization of a device, can be combined in order to achieve a practical lab-on-a-chip capable of handling quite a small sample. Many different commercially available membranes can perform various functions that may be needed for analyses, such as filtration, ion-exchange, reagent release, laminar flow, and absorption (References: S. H. Paek et al. 1999, Biotechnol. Bioeng., Vol. 62, page 145-153; Y Kasahara et al., 1997, Clin. Chimi. Acta. Vol. 267, page 87-102). The membranes can be cut to widths of 1 mm or narrower, and then installed within the channels of a plastic chip. This approach facilitates precise arrangement and assembly of the small pieces of membranes together for the fabrication of a functional lab-on-a-chip.

The present invention makes it the object to provide the said novel device that would offer three advantages in addition to sample reduction: 1) realization of variable functions by selecting appropriate membranes mentioned; 2) implantation of membranes as parts of a complete channel for total analysis; and 3) transfer of medium by capillary action without the assistance of an external force.

### DISCLOSURE OF THE INVENTION

The present invention relates to a lab-on-a-chip version of biosensor system that comprises
(a) a solid matrix as the top plate (20),
(b) one functional membrane pad, or more, (10) prepared in a dry state, and
(c) a solid matrix as the bottom plate (30).

The lab-on-a-chip is built by accomplishing:
(I) the inner surfaces of the top plate (or the bottom plate depending on the design) is engraved to form micro- to millimeter-sized micro-fluidic channels (21, 28) comprising parts for holding the said functional membrane pad(s) and parts for controlling the inlet(s) and outlet(s) of medium by capillary action;
(II) the functional membrane pad(s) (10) is placed within at least a part of the channels; and, finally,
(III) the bottom plate is bonded to the top plate in order to compose micro-fluidic channels (21, 28) for delivering medium by capillary action.

In the above, the top solid plate (20) can variably contain sample application pot (22), signal monitoring window (23), and enzyme substrate supply pot (25), and the bottom solid plate (30) can also include inlet/outlet pots of medium depending on the design of lab-on-a-chip.

The said top solid plate (20) is made of organic polymers, such as polydimethylsiloxane (PDMS), polymethylmethacrylate (PMMA), polystyrene, and polycarbonate, and inorganic materials, such as glass, quartz, and ceramic. The bottom solid plate (30) is made of one of the same materials as for the top plate or, in addition, flexible solid matrices such as adhesive plastic film and rubber.

The said micro-fluidic channel (21, 28) is formed on the inner surfaces of the top solid plate using various methods, for instances, photolithography, imprinting, laser and mechanical engraving. The channel may have a planar, smooth slant, or multi-layer structure depending on the design of lab-on-a-chip.

The said membrane pad(s) (10) is selectable from glass fiber membrane, cellulose membrane, nitrocellulose membrane, nylon membrane, and a synthetic polymer membrane. In this invention, functional membrane is defined as a part ready to use for analysis in a lab-on-a-chip (40) after appropriate treatments of a raw membrane. The lab-on-a-chip (40), therefore, can be constructed to accomplish desired functions by selecting membranes among available ones carrying out filtration, ion-exchange, reagent release, laminar flow, absorption, enzyme reaction, antigen-antibody binding, and nucleic acid hybridization.

The lab-on-a-chip (40) from this invention is utilized for analyses of a variety of analytes including metabolic substances, proteins, hormones, nucleic acids, cells, drugs, food contaminants, environmental pollutants, and biological weapons. They are detected with high specificity and sensitivity by employing bio-receptors, such as enzyme, antibody, and oligonucleotide, placed within the micro-pores of the functional membranes. Such a biological interaction among analyte and bio-receptor is converted to a physical signal (e.g., color, luminescence, fluorescence, electric current, voltage, conduction, or magnetism), resulting from the interaction itself or via a signal generator usually labeled to one of the reaction partners, readily measurable using a relatively simple detector.

In the above lab-on-a-chip version of biosensor system, the micro-fluidic channels may comprise a vertical micro-fluidic channel (21) and a horizontal micro-fluidic channel (28) crossing with one another, wherein the horizontal micro-fluidic channel (28) may comprise a substrate supply channel (24) and a horizontal flow absorption channel (26).

The vertical micro-fluidic channel (21) may be integrated with sample application pad (12), signal generator conjugate release pad (13), cell filtration pad (14), signal generation pad with immobilized capture binding component (15), and vertical flow absorption pad (16); and the horizontal flow absorption channel (26) may be prepared to be wholly integrated with a horizontal flow absorption pad (17). In such a case, the horizontal flow absorption pad (17) is remained in a spatially separated state at first and then physically connected to the signal generation pad (15), belong to the vertical arrangement pads, after the completion of the vertical flow reaction.

In the above, the horizontal flow absorption channel (26) may also be prepared in a combined structure of connection fine-capillary channels (42), having a defined width and length, with parts integrated with a horizontal flow absorption pad (17), wherein the fine-capillary channels (42) is located between the signal generation pad with immobilized capture binding component (15) and the horizontal flow absorption pad (17) and may have a dimension of 1 to 900 μp width and 0.1 to 10 mm length. In such a case, the movement of the horizontal absorption pad (17) for signal generation is not required as shown in FIG. 2B (right).

In the above, the signal generator conjugate release pad (13) may comprise the conjugate of a signal generator with a binding component for detection, or a binding component for detection and the conjugate of a signal generator with a secondary binding component specific to the binding component for detection.

In case that the signal generator is horseradish peroxidase, alkaline phosphatase, β-galactosidase, urease, or arthromyces ramosus peroxidase, the substrate solution may comprise a chromogenic substrate component specific to the signal generator, and, at the time of signal generation, a color change detectable with naked eyes is shown as signal resulting from enzyme-substrate reaction.

In case that the signal generator is gold colloids, the substrate solution may comprise a silver compound, and, at the time of signal generation, a color change detectable with naked eyes or conductivity change is measured as signal resulting from chemical catalytic reaction.

In case that the signal generator is horseradish peroxidase or arthromyces ramosus peroxidase, the substrate solution may comprises luminol or other luminescent substrate components specific to the signal generator, an enzyme, and at the time of signal generation, a light signal is measured as signal resulting from enzyme-substrate reaction.

In case that the signal generator is Co²⁺, Cu²⁺, Mg²⁺, Fe²⁺or their compounds, the substrate solution may comprise luminol or other luminescent substrate components specific to the signal generator, and at the time of signal generation, a light signal is measured as signal resulting from chemical catalytic reaction.

In case that the signal generator is glucose oxidase, urease, penicillin oxidase, or cholesterol oxidase, the substrate solution may comprise an electrochemical signal-generating component specific to the signal generator, an enzyme, and, at the time of signal generation, electric conductivity change, current change, or voltage change is measured as signal resulting from enzyme-substrate reaction.

In the above, the electrochemical signal may be detected using an electrode either directly screen-printed onto the signal generation pad or physically combined with the pad by means of an external force.

Besides lab-on-a-chip, a detector measuring a signal produced from the chip is also an essential component of the biosensor system. The signal can be measured based on, for examples, colorimetry, luminometry, fluorometry, electrochemistry, or magnetometry, depending on the signal to be measured. For demonstration, a colorimetric detector (50) can be constructed to measure a color change of bio-receptor-dispensed lines on the signal generation pad (15) of lab-on-a-chip using a charge-coupled device (CCD) camera (51). The signal detected is processed by an image capture program, and displayed on an output module.

Although the lab-on-a-chip in this invention can be applied for the analyses of a number of analytes, biological affinity-based analyses such as immunoassay based on antigen-antibody binding are selected for illustrating the utility of the lab-on-a-chip.

Lab-On-A-Chip for Immuosensors

Enzyme-linked immunosorbent assay (ELISA) is an analytical method that utilizes solid-phase immune reactions to detect an analyte in sample via an enzyme labeled to an immuno-reagent as a signal generator (References: G. G. Guilbault, 1968, Anal. Chem., Vol. 40, page 459-471). In this type of assay, a binding reaction partner, antigen or antibody, is typically immobilized on the solid surfaces of microtiter plates consisting of multiple, small-volume capacity wells made of plastic (e.g., polystyrene). Such features of the analytical system not only allowed us an easy separation of the antigen-antibody binding complexes from unbound reagents by washing the surfaces, but also allowed us to simultaneously process a number of samples for either qualitative or quantitative measurements (References: E. Engvall et al., 1971, Immunochem., Vol. 8, page 871-873; G. J. Kasupski et al., 1984, Am. J. Clin. Pathol., Vol. 81, page 230-232). For these reasons, since its introduction in 1971, it has been widely applied to various fields of analysis, such as medical diagnostics, biological assays, food and environmental monitoring, and veterinary examination (References: C. Heeschen et al., 1999, Clin. Chem., Vol. 45, page 1789-1796; M. O. Peplow et al., 1999, Appl. Environ. Microbiol., Vol. 65, page 1055-1060; J. Chin et al., 1989, Vet. Immunol. Immunopathol., Vol. 20, page 109-118).

Compared to other signal generators, such as radioisotopes and fluorophore, the enzymes used as signal generators in ELISA are huge, proteinacious molecules, which catalyze each specific substrate (References: L. J. Kricka, 2002, Ann Clin. Biochem., Vol. 39, page 114-129). The catalytic action amplifies the signal, which, depending on its chemical properties, can be measured using a simple detector based on colorimetry, luminometry, and electrochemistry, for example (References: A. Morrin et al., 2003, Biosens. Bioelectron., Vol. 18, page 715-720; R. J. Jackson et al., 1996, J. Immunol. Methods., Vol. 190, page 189-197; W. O. Ho et al., 1995, Biosens. Bioelectron., Vol. 10, page 683-691; J. Zeravik et al., 2003, Biosens. Bioelectron., Vol. 18, page 1321-1327). However, because of their huge molecular sizes, it is difficult to label them to immuno-reagents without interferences in antigen-antibody bindings, which rarely occurs with the small signal generators. Enzymes are, moreover, sensitive to environmental variables, including inhibitory substances that may be inadvertently present in samples, and may alter their activities as catalysts. Nevertheless, such unfavorable factors, although decidedly important, have not significantly restrained their utilization as signal generators, and ELISA has been a routine, standard laboratory method for analyses of complex organic substances for the last two decades (References: E. Engvall et al., 1971, Immunochem., Vol. 8, page 871-873; J. Zeravik et al., 2003, Biosens. Bioelectron., Vol. 18, page 1321-1327).

In spite of its popularity, ELISA has rarely been applied to practical analyses conducted outside of the laboratory. This is due to the presence of a repetitive addition and the removal of reagents required during the analytical procedure, even though considerable progress had been made in towards automation of the ELISA procedure. For on-the-spot-analysis, particularly, point-of-care testing (POCT) in clinical diagnostics, a method of immuno-chromatography has been developed which utilizes membrane strips as a solid matrix (References: S. H. Paek et al., 2000, Methods, Vol. 22, page 53-60). Signal generators used in this format are mostly gold colloids or Latex beads, of which colors, as a result of assays, can be detected by the naked eye (References: T. Ono et al., 2003, J. Immunol. Methods, Vol. 272, page 211-218; J. H. Cho et al., 2001, Biotech. Bioeng., Vol. 75, page 725-732). Although it can offer several advantages in POCT, such as rapid, one-step analysis, the low sensitivity of the assay has been considered a major drawback. Alternatively, other types of signals, fluorescence and magnetic field, for example, have been explored in the efforts to develop high detection-capability immunosensors (References: F. S. Apple et al., 1999, Clin. Chem., Vol. 45, page 199-205; M. R. Blake et al., 1997, Appl. Environ. Microbiol., Vol. 63, page 1643-1646). These sensors have been available for diagnosis of acute cardiac syndrome in the market. However, some limitations in expanding the same technologies to other conventional products are expected because of their high cost and bulky dimensions, keeping portability in mind.

For illustrating the utility of the lab-on-a-chip proposed in this invention, a POCT version of ELISA is developed by employing the method of cross-flow chromatography (References: J. H. Cho et al., 2005, Anal. Chem., Vol. 77, page 4091-4097). This would demonstrate a widespread application of immunosensors to various analytes with minimal costs and, potentially, dimensions. The concept was originally developed to use enzymes as signal generators in immuno-chromatographic assay by sequentially accomplishing antigen-antibody bindings and catalytic reactions to generate signals. A lab-on-a-chip is constructed in this invention to achieve a semi-automatic switching of the sequential processes for a complete analysis and a miniaturization of the immunosensor. This chip is fabricated as stated above by incorporating a conventional immuno-strip into a plastic chip with elaborately devised channels on the surfaces.

Lab-On-A-Chip Immunosensor System

To fabricate a lab-on-a-chip installed with membrane pads for ELISA, fluidic channels are devised by mechanically etching the surfaces of the top solid plate (20). The chip consists of two distinct flow channels in the vertical (21) and horizontal directions (28; FIG. 1A). The vertical compartment (21) is carved to tightly fit a 2 mm-wide immuno-strip (11), essentially the same as that of a conventional rapid test kit (References: J. G. Schwartz et al., 1997, Am. J. Emerg. Med., Vol. 15, page 303-307; R. H. Christenson et al., 1997, Clin. Biochem., Vol. 30, page 27-33), except it also used an enzyme signal generator (e.g., horseradish peroxidase; HRP). A sample application pot (22) and a signal monitoring window (23) are provided by drilling. To induce a subsequent horizontal flow, an enzyme substrate supply channel (24) and a horizontal flow absorption channel (26) are horizontally arranged on each lateral side of the signal generation pad (15) of the strip, respectively. In the substrate supply channel (24), a supply pot (25) and two air ventilation holes (27) are located at the inlet and near the outlet, respectively.

Two membrane components, the immuno-strip (11) and the horizontal flow absorption pad (17), are prepared for installation into the chip (FIG. 1B). The immuno-strip (11) is comprised of four different, commercially available membranes, furnishing various functions of sample application (12), enzyme conjugate release (13), cell filtration (14), signal generation (15), and vertical flow absorption (16). They are lengthily disposed in order, partially superimposed on one another, and mounted on a plastic film. This strip is fixed in the vertical channel (21) of the chip. The position of the horizontal flow absorption pad (17), on the other hand, is variable. If used for analysis, it is placed in a spatially separate position from the immuno-strip (11) at the beginning, and, after the completion of the vertical flow, it is slid onto the lateral side of the signal generation pad (15) to initiate the horizontal flow of an added substrate solution. The channels with such installed membrane components are closed by bonding the bottom solid plate (30) to fabricate a functional lab-on-a-chip (FIG. 1C) that can be used for quantifying an analyte in samples.

Using the lab-on-a-chip, the cross-flow chromatographic analysis for an analyte is performed. The analyte is spiked in a human serum to prepare a standard solution, which is then transferred into the sample application pot (22) of the chip (40; FIG. 2A). It is migrated in the vertical direction by capillary action (FIG. 2A, left), and dissolves the detection antibody labeled with an enzyme (e.g., HRP), which triggers bindings between this enzyme conjugate and the analyte molecules in the liquid phase. Such binding complexes are carried into the signal generation pad (15), where the immobilized capture antibody binds them to form a sandwich type of complex. At the time of a complete removal of the excess components, a solution containing a chromogenic substrate for HRP (e.g., insoluble TMB) is supplied into the corresponding pot and, at the same time, the horizontal flow absorption pad (17) is connected to the lateral side of the signal generation pad (15; FIG. 2A, right). Upon initiation of the flow of substrate, a color signal at the site of the immobilized antibody is produced in proportion to the analyte concentration. A control is also run to monitor the consistency of the assay using a secondary antibody, recognizing the detection antibody, immobilized at a site on the signal generation (see the color signal and control in FIG. 2A, right).

In another model (41; FIG. 2B) adopting non-contact between the horizontal absorption pad (17) and the signal generation pad (15), the configuration is essentially identical to that of the contact type (FIG. 2A) except the presence of connection fine-capillary channels (42) between the two pads in the non-contact model. Such model does not require the movement of the horizontal absorption pad (17) for signal generation as shown in FIG. 2B (right). The idea of installation of connection capillary channels can be further expanded in horizontally connecting a multiple vertical channels in parallel toward the substrate flow.

In order to quantify the color signal, a detector (FIG. 3A) is built based on image capture using a digital camera. After analysis, the chip with colored signals is placed under the camera, and the color densities which appeared on the signal generation pad are digitized in the vertical direction using a software program. The data are collected and stored in the Microsoft Excel program installed on a personal computer. For the purpose of applying the chip for point-of-care testing, a PDA-based portable prototype detector is further demonstrated as shown in FIG. 3B.

### BRIEF EXPLANATION OF DRAWINGS

FIG. 1 shows construction of an analytical lab-on-a-chip for ELISA adopting the concept of cross-flow chromatography.

(A): Top solid plate with micro-fluidic channels engraved on the surfaces;

(B): Top solid plate with membranes implanted within the micro-fluidic channels; and

(C): Construction of lab-on-a-chip for immuno-analysis (Model A).

FIG. 2 shows analytical procedures using the lab-on-a-chip as shown in FIG. 1 (Model A) and the same chip except the presence of connection fine-capillary channels (42; Model B).

FIG. 3 shows a schematic diagram of detector for the color signal produced from the lab-on-a-chip sensor (A) and a PDA-based portable prototype detector built as an example (B).

FIG. 4 shows calibration curve of the lab-on-a-chip and signal detector system for cTnI. The signal and control are quantified by integration of the color densities under the respective peaks. Each standard deviation of replicate measurements is indicated.

### EXPLANATION OF MARKS IN THE DRAWINGS

10: Functional membrane pads
11: Immuno-strip with 2-mm width
12: Sample application pad
13: Enzyme conjugate release pad
14: Cell filtration pad
15: Signal generation pad
16: Vertical flow absorption pad
17: Horizontal flow absorption pad
20: Top solid plate
21: Vertical micro-fluidic channel
22: Sample application pot
23: Signal monitoring window
24: Horizontal substrate supply channel
25: Enzyme substrate supply pot
26: Horizontal flow absorption channel
27: Air ventilation holes
28: Horizontal micro-fluidic channel
30: Bottom solid plate
31: Bypass prevention hole
40: Lab-on-a-chip model A for immuno-analysis
41: Lab-on-a-chip model B for immuno-analysis
42: Connection capillary channels (2-mm long)
55: Colorimetric detector
51: Charge-coupled device (CCD) camera
52: Light source
53: Connector
54: Input/output module
55: Charging equipment

### BEST MODE FOR CARRYING OUT THE INVENTION

The following Examples support more specifically the content of the present invention and show its usefulness through demonstration of specific applications, yet never limits the scope of the present invention. In particular, it has been applied to immuno-analysis of an analyte requiring higher sensitivity, cardiac troponin I (cTnI), as a specific marker of acute myocardial infarction (AMI).

### MATERIAL USED IN EXAMPLES

Polymethylmetacrylate (PMMA) was obtained from LG Chem (PMMA IF870, Seoul, Korea). A stock of cardiac troponin (cTn) I-T-C complex, cTnI single molecule for immunization, and a monoclonal antibody (Clone 19C7) specific to cTnI were supplied by Hytest (Turku, Finland). Human anti-mouse antibody (HAMA) blocker (mouse IgG fraction) and a cardiac marker control were obtained from Chemicon International (Temecula, Calif.) and Cliniqa (Fallbrook, Calif.), respectively. N-succinimidyl-3-(2-pyridyldithio) propionate (SPDP), succinimidyl 4-(N-maleimidomethyl)cyclohexane-1-carboxylate (SMCC), and dithiothreitol (DTT) were purchased from Pierce (Rockford, Ill.). Goat anti-mouse antibody, casein (sodium salt type, extracted from milk), human serum (frozen liquid), Triton X-100, Sephadex G-15, and G-100 were supplied by Sigma (St. Louis, Mo.). Nitrocellulose (NC) membrane (12-m pore size) and glass fiber membrane (Ahlstrom 8980) were obtained from Millipore (Bedford, Mass.). Cellulose membrane (17 CHR chromatography grade) and glass fiber membrane (Rapid 24Q) were purchased from Whatman (Maidstone, England). Horseradish peroxidase (HRP) was supplied by Calbiochem (San Diego, Calif.), and its substrate containing insoluble 3,3′,5,5′-tetramethylbenzidene (TMB) was supplied by Moss (Pasadena, Md). All other reagents used were of analytical grade.

### Example 1

### Synthesis of HRP-Labeled Antibody

1-1. Production of Monoclonal Antibody

A monoclonal antibody specific to cTnI was raised through the adoption of a standard protocol. cTnI (30 g) was emulsified with Complete Freund's adjuvant and injected into the peritoneal cavity of a 6-week old Balb/c mouse. After 3 weeks, the mouse was immunized with the same amount of cTnI emulsified with Incomplete Freund's adjuvant. An identical procedure was repeated 2 weeks later, and the final immunization was conducted after the same period with cTnI dissolved in 10 mM phosphate buffer, pH 7.4, (PB) containing 140 mM NaCl (PBS). Three days after the final boosting, the mouse splenocytes were collected and fused with murine plasmacytoma (sp2/0 Ag 14) as a fusion partner. Fused hybridoma cells were screened based on HAT selection, and a cell clone producing antibody specific to cTnI (BD Clone 12) was finally screened by immunoassay using antigen-coated microtiter plates. This antibody was produced as ascitic fluid from a Balb/c mouse and was then purified on a protein G column (5 mL, HiTrap protein G HP; Amersham Biosciences, Piscataway, N.J.). The eluted IgG fractions were pooled, concentrated, dialyzed against PBS, and frozen as aliquots until later use.

1-2. Conjugation Between Antibody and HRP

The monoclonal antibody (BD Clone 12) was chemically coupled with HRP using cross-linkers as described in a previous report (References: J. H. Cho et al., 2005, Anal. Chem., Vol. 77, page 4091-4097). In brief, the antibody (total 1 mg, 0.5 mL) and HRP (total 1.4 mg, 0.5 mL) dissolved in 100 mM PB containing 5 mM ethylenediaminetetraacetic acid disodium salt were coupled with SMCC and SPDP dissolved in dimethyl sulfoxide (DMSO), respectively. The coupled SPDP linker was activated using DTT, and both modified proteins were fractionated by means of Sephadex G-15 gel chromatography. The antibody was then immediately combined with the HRP in a 5 molar excess and reacted overnight at 4° C. This mixture was purified on a Sephadex G-100 gel column (10×200 mm). The purified conjugates were quantified by the Bradford method (References: R. C. Duhamel, 1983, Coll. Relat. Res. 1983, Vol. 3, page 195-204), and stored as aliquots after snap freezing.

### Example 2

### Construction of Lab-on-a-Chip

2-1. Preparation of Immuno-Strip

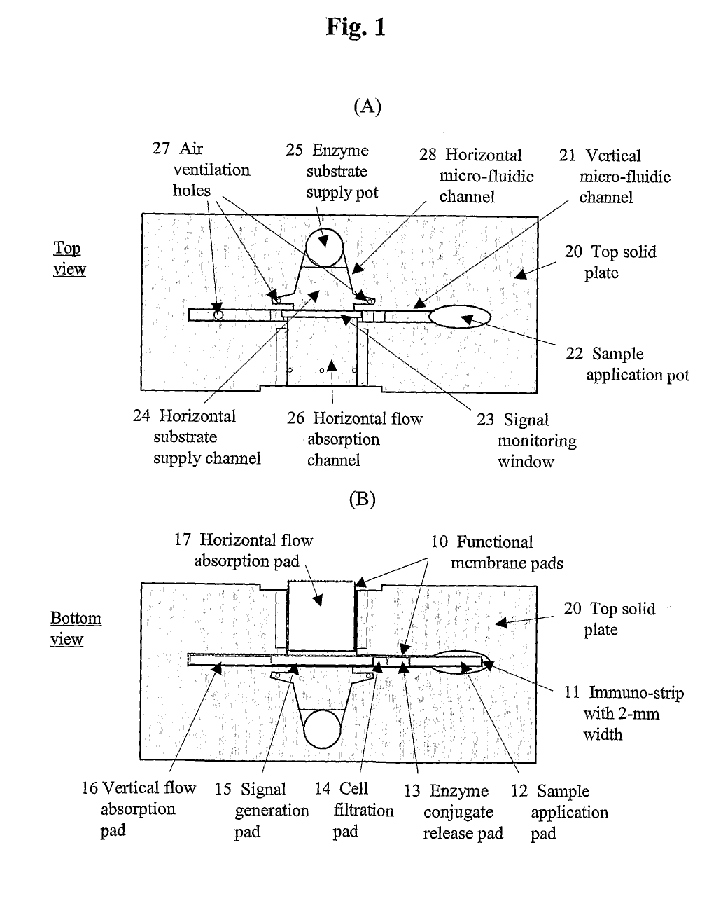

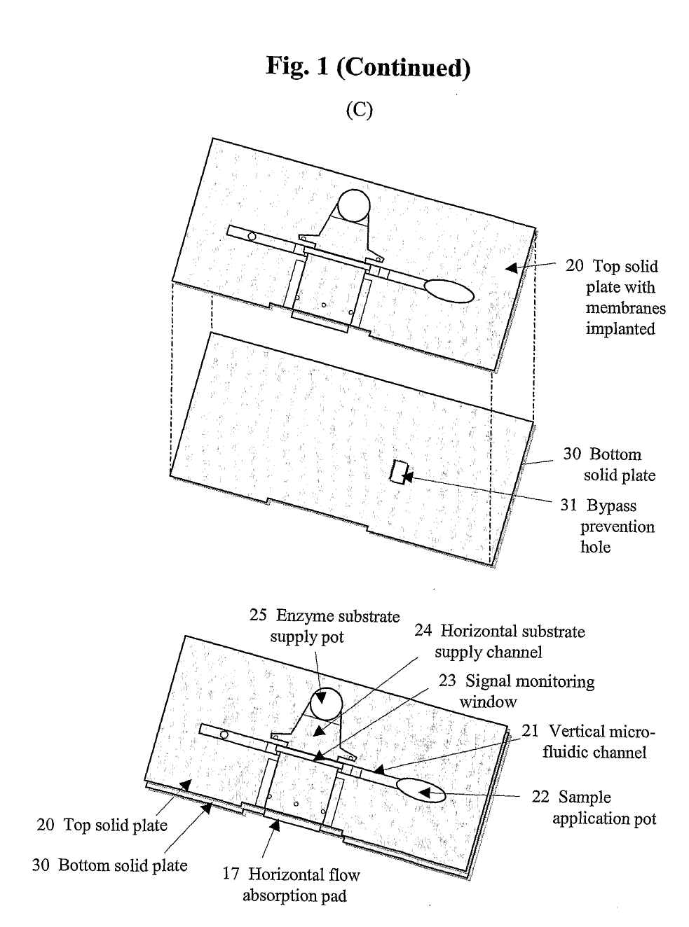

To accomplish the immuno-chromatographic assay for cTnI in the vertical direction, four different functional membrane pads have been employed (refer to FIG. 1B). Each sample application pad was a glass fiber membrane (2×15 mm; Ahlstrom 8980) pre-treated with polyvinyl alcohol by the manufacturer. A conjugate release pad was fabricated by transferring 8 L of a conjugate solution onto a glass membrane (2×5 mm; Rapid 24Q). The conjugate solution was prepared by diluting the HRP labeled-antibody (2.5 g/mL) with 100 mM PB containing 0.5% casein (Casein-PB), HAMA blocker (150 g/mL), ascorbic acid (5 mM), Triton X-100 (0.5%, v/v), and trehalose (20%, w/v). A signal generation pad was made by dispensing (1.5 L/cm) the monoclonal antibody (Clone 19C7; 2 mg/mL) in PBS onto a site at 10 mm from the bottom of NC membrane (2×25 mm) using a microdispenser (BioJet 3000, Biodot, Irvine, Calif.). On the same membrane, goat anti-mouse antibody (0.2 mg/mL) in PBS was also dispensed onto a site at 17 mm from the bottom. After drying at 37° C. for 1 h, the membrane was kept in a desiccator at room temperature until use.

The prepared membrane pads were arranged to be a width of 2 mm, in order from the bottom, sample application pad, conjugate release pad, cell filtration pad, signal generation pad, and a cellulose membrane (2×15 mm) as an absorption pad. Finally, a fictional immuno-strip was constructed by partially superimposing each contiguous membrane strip and fixing them on a plastic film using double-sided tape.

2-2. Etching of Plastic Chip

Fluidic channels were made by mechanically engraving the surfaces of a polyacrylamide chip (32×76×2 mm), essentially enabling us to comprise the immuno-strip in the vertical position as a part of fluidic channels and to deliver an aqueous solution crosswise (see FIG. 1A for the overall structure). An immuno-strip mounting channel was arranged in the center of the chip by carving the surface to a width of 2 mm, a length of 51 mm, and variable depths, adapting the different thicknesses of each membrane pad of the strip. The bottom of the channel was drilled in an oval shape (5×10 mm) to provide a sample application pot with a maximum sample holding capacity of 100 L. A signal monitoring window was furnished by slitting the chip surface (1×18 mm) corresponding to the ceiling of the signal generation pad of the strip. To allow for a flow across this pad, an enzyme substrate supply channel and a horizontal flow absorption channel were installed on each opposing side of the vertical channel. On one side, a substrate supply channel with a depth of 0.8 mm was formed in a shape of a circular triangle expanded to the vertical channel as shown in FIG. 1. A substrate supply pot (7-mm diameter) was installed by drilling the surface at an inlet of the channel. Two air ventilation holes (1-mm diameter) were also made at both of the end projection areas near the outlet of the channel. On the other side of the vertical channel, a horizontal flow absorption channel for the flow was built to specific dimensions: a width of 14 mm, length of 12 mm, and a depth of 1 mm.

2-3. Assembly of Lab-on-a-Chip

The etched plastic chip was integrated with the immuno-strip and a horizontal flow absorption pad by installing them into the vertical channel and the horizontal flow absorption channel, respectively. The absorption pad was prepared by attaching the cellulose membrane (14×12 mm) to a plastic film using a double-sided tape. The integrated chip was closed by covering with a laminating film and then bonding an intact plastic chip of the same size using double-sided tape. The chip was finally kept in a desiccator maintained at room temperature until use.

### Example 3

### Characterization of Analytical Performances

3-1. Preparation of Standard Samples of cTnI

A stock of cTnI (1 mg/mL; I-T-C complex form) was serially diluted with human serum to prepare samples at pre-determined concentrations. The serum itself was regarded as the negative sample.

3-2. Calibration

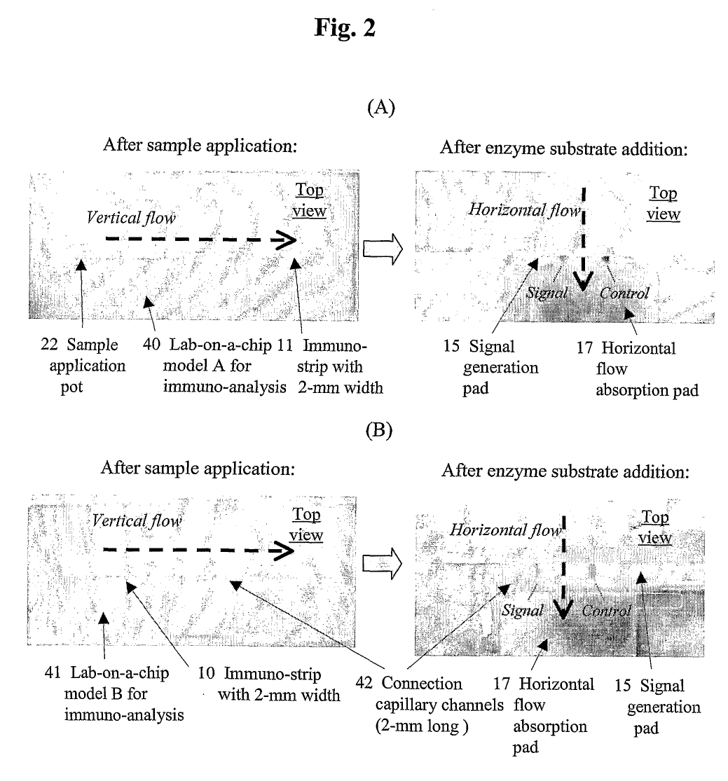

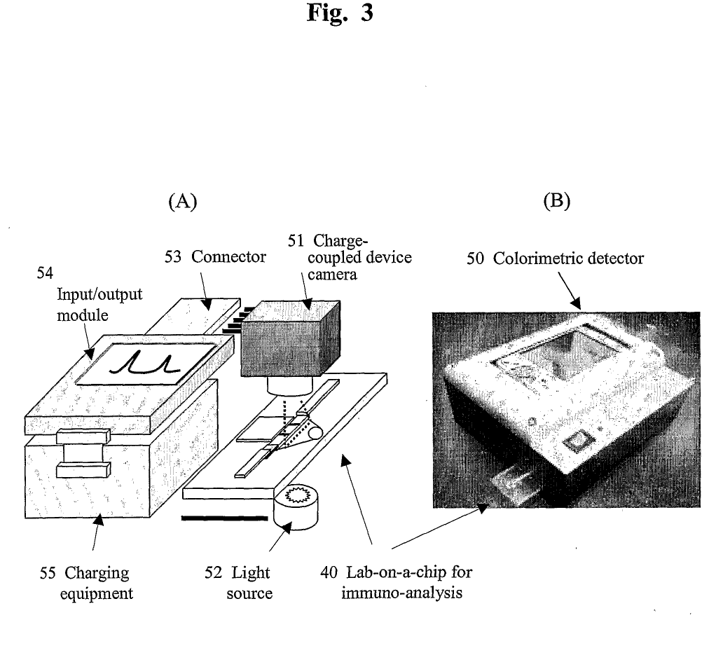

Under optimal conditions, the responses of the lab-on-a-chip to the analyte concentrations were obtained using the standard samples of cTnI. The samples were added into different lab-on-a-chip, the immune reactions were processed for 15 min and, sequentially, the signal generation was processed for 5 min after the enzyme substrate was supplied. The chip with colored signals as shown in FIG. 2 was placed under a digital camera (FA185A#ABA, Hewlett-Packard, Palo Alto, Calif.) built within a detector and illuminated from the bottom using a light source (SR0307A-5230, Seho Robot, South Korea) as shown in FIG. 3. The image of the signal generation pad was captured and the color densities which appeared on the pad were digitized in the vertical direction using software programmed in C⁺⁺ language, installed on a personal computer. The data were collected and stored in the Microsoft Excel program. In order to quantify the signal proportional to the analyte dose, the measured optical densities were first subtracted from the mean value of the background colors present between the signal and control peaks. The normalized optical densities under the signal peak were then integrated so that a numerical signal value could be assigned. The same procedure was repeated three times, and the mean values at each concentration were used to plot a graph of the dose-response curve.

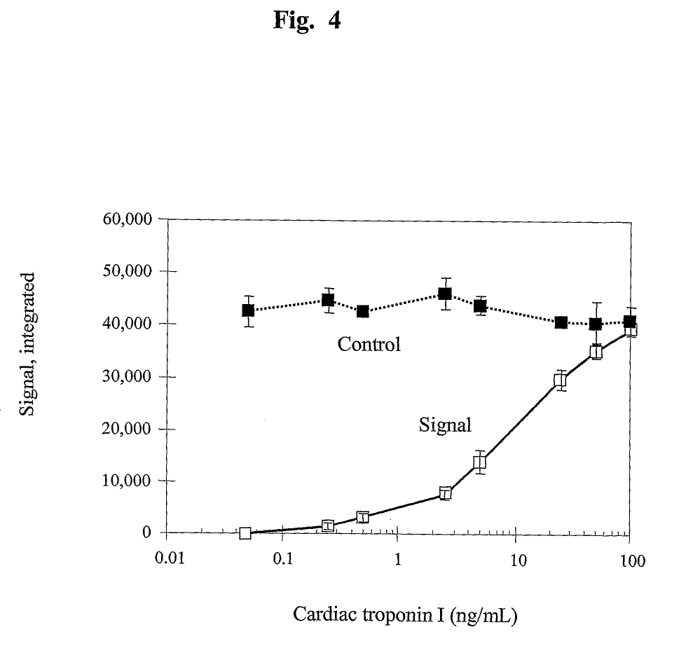

The dose-response curve of the sensor using standard samples of cTnI was plotted in a semi-log graph as shown in FIG. 4. The signal varied in a sigmoidal shape, while the control was kept approximately constant regardless of the dose of analyte. For an accurate calibration, the sigmoidal curve can be converted to a straight line by means of the log-logit transformation (References: A. DeLean et al., 1978, Am. J. Phys., Vol. 235, page 97-102), which is then used for quantifying the analyte in unknown samples. From the calibration curve, the detection limit of the lab-on-a-chip sensor was found to be approximately 0.1 ng/mL, and the quantification limit was found to be 0.25 ng/mL when the selected cTnI was used as a calibrator.

### INDUSTRIAL APPLICABILITY

The present invention provides a membrane-implanted lab-on-a-chip offering a minimal sample requirement and analytical functions necessary for simultaneously measuring multiple prognostic or diagnostic indicators. The chip led the sample flow through the channel merely by capillary action without using an external driving force, which would allow the use of the device for on-the-spot-analysis. Since the device is a miniaturized version for sample reduction that would alleviate, in case of clinical diagnosis, a refusal against finger prick, it would be suitable for a frequent testing of symptoms and diseases with a high sensitivity and at an economical price.

1. A lab-on-a-chip version of biosensor system characterized to comprise
(a) a solid matrix as the top plate (20),
(b) one functional membrane pad, or more, (10) prepared in a dry state, and
(c) a solid matrix as the bottom plate (30),
wherein the chip is built by accomplishing:
(I) the inner surfaces of the top solid plate (or the bottom solid plate depending on the design) is engraved to form micro- to millimeter-sized micro-fluidic channels (23) comprising parts for holding the said functional membrane pad(s) and parts for controlling the inlet(s) and outlet(s) of medium by capillary action;
(II) the functional membrane pad(s) (10) is placed within at least a part of the channels; and
(III) the bottom solid plate is bonded to the top plate in order to compose micro-fluidic channels (21, 28) for delivering medium by capillary action.

2. The lab-on-a-chip version of biosensor system of claim 1, wherein the top solid plate (20) comprises sample application pot (22), signal monitoring window (23), and enzyme substrate supply pot (25), and the bottom solid plate (30) comprises inlet/outlet pots of medium depending on the design of lab-on-a-chip.

3. The lab-on-a-chip version of biosensor system of claim 1, wherein the top solid plate (20) is made of polydimethylsiloxane (PDMS), polymethylmethacrylate (PMMA), polystyrene, polycarbonate, glass, quartz, or ceramic, and the bottom solid plate (30) is made of the same materials as for the top plate or flexible solid matrices.

4. The lab-on-a-chip version of biosensor system of claim 1, wherein the micro-fluidic channels (23) are formed on the inner surfaces of the top solid plate using photolithography, imprinting, laser, or mechanical engraving, to have a planar, smooth slant, or multi-layer structure depending on the design of lab-on-a-chip.

5. The lab-on-a-chip version of biosensor system of claim 1, wherein the functional membrane pad(s) (10) is selected from the group consisting of glass fiber membrane, cellulose membrane, nitrocellulose membrane, nylon membrane, and synthetic polymer membranes.

6. The lab-on-a-chip version of biosensor system of claim 1, wherein the functional membrane pad(s) (10) accomplishes at least one role selected from the group consisting of filtration, ion-exchange, reagent release, laminar flow, absorption, enzyme reaction, antigen-antibody binding, nucleic acid hybridization, and signal generation.

7. The lab-on-a-chip version of biosensor system of claim 1, wherein the functional membrane pad(s) (10) comprises at least one functional membrane pad containing binding component(s) selected from the group consisting of enzyme, antibody, and oligonucleotide, that are used for detection of analytes with high specificity and sensitivity.

8. The lab-on-a-chip version of biosensor system of claim 7, wherein the biological interaction among analyte and binding components is converted to a physical signal resulting from the interaction itself or via a signal generator usually labeled to one of the reaction partners, which is measured using a detector based on a change of color, luminescence, fluorescence, electric current, voltage, conduction, or magnetism.

9. The lab-on-a-chip version of biosensor system of claim 8, wherein the analyte is metabolic substance, protein, hormone, nucleic acid, cell, drug, food contaminant, environmental pollutant, or biological weapon.

10. The lab-on-a-chip version of biosensor system of claim 1, wherein the micro-fluidic channels comprise a vertical micro-fluidic channel (21) and a horizontal micro-fluidic channel (28) crossing with one another, wherein the horizontal micro-fluidic channel (28) comprises a substrate supply channel (24) and a horizontal flow absorption channel (26).

11. The lab-on-a-chip version of biosensor system of claim 10, wherein the vertical micro-fluidic channel (21) is integrated with sample application pad (12), signal generator conjugate release pad (13), cell filtration pad (14), signal generation pad with immobilized capture binding component (15), and vertical flow absorption pad (16); and, the horizontal flow absorption channel (26) is prepared by wholly installing a horizontal flow absorption pad (17).

12. The lab-on-a-chip version of biosensor system of claim 10, wherein the vertical micro-fluidic channel (21) is integrated with sample application pad (12), signal generator conjugate release pad (13), cell filtration pad (14), signal generation pad with immobilized capture binding component (15), and vertical flow absorption pad (16); and, the horizontal flow absorption channel (26) is prepared in a combined structure of connection fine-capillary channels (42), having a defined width and length, with parts integrated with a horizontal flow absorption pad (17), wherein the fine-capillary channels (42) is located between the signal generation pad with immobilized capture binding component (15) and the horizontal flow absorption pad (17).

13. The lab-on-a-chip version of biosensor system of claim 11, wherein the horizontal flow absorption pad (17) is remained in a spatially separated state at first and then physically connected to the signal generation pad (15), belong to the vertical arrangement pads, after the completion of the vertical flow reaction.

14. The lab-on-a-chip version of biosensor system of claims 11 and 12, wherein signal generator conjugate release pad (13) comprises the conjugate of a signal generator with a binding component for detection, or a binding component for detection and the conjugate of a signal generator with a secondary binding component specific to the binding component for detection.

15. The lab-on-a-chip version of biosensor system of claim 14, wherein the signal generator is horseradish peroxidase, alkaline phosphatase, β-galactosidase, urease, or arthromyces ramosus peroxidase, and the substrate solution comprises a chromogenic substrate component specific to the signal generator, and, at the time of signal generation, a color change detectable with naked eyes is shown as signal resulting from enzyme-substrate reaction.

16. The lab-on-a-chip version of biosensor system of claim 14, wherein the signal generator is gold colloids and the substrate solution comprises a silver compound, and, at the time of signal generation, a color change detectable with naked eyes or electric conductivity change is measured as signal resulting from chemical catalytic reaction.

17. The lab-on-a-chip version of biosensor system of claim 14, wherein the signal generator is horseradish peroxidase or arthromyces ramosus peroxidase, and the substrate solution comprises luminol or other luminescent substrate components specific to the signal generator, and at the time of signal generation, a light signal is measured as signal resulting from enzyme-substrate reaction.

18. The lab-on-a-chip version of biosensor system of claim 14, wherein the signal generator is Co²⁺, Cu²⁺, Mg²⁺, Fe²⁺, or one of their compounds and the substrate solution comprises luminol or one of other luminescent substrate components specific to the signal generator, and, at the time of signal generation, a light signal is measured as signal resulting from chemical catalytic reaction.

19. The lab-on-a-chip version of biosensor system of claim 14, wherein the signal generator is glucose oxidase, urease, penicillin oxidase, or cholesterol oxidase, and the substrate solution comprises an electrochemical signal-generating component specific to the signal generator, and, at the time of signal generation, electric conductivity change, current change, or voltage change is measured as signal resulting from enzyme-substrate reaction.

20. The lab-on-a-chip version of biosensor system of claims 16 and 19, wherein the electrochemical signal is detected using an electrode either directly screen-printed onto the signal generation pad or physically combined with the membrane pad by means of an external force.
